(19) United States
(12) Patent Application Publication
(10) Pub. No.: US 2003/0171124 A1
(43) Pub. Date: Sep. 11, 2003

(54) Communication traffic control method

(76) Inventor: Masayuki Kataoka, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/344,408

(22) PCT Filed: Jun. 14, 2001
(86) PCT No.: PCT/JP01/05068

(51) Int. Cl. H04Q 7/20

(52) U.S. Cl. 455/453; 455/436; 455/444

(57) ABSTRACT

A communication traffic control method is performed for a hierarchy mobile communication system having a plurality of mobile stations 9a and 9b, a plurality of microcells 7a and 7b and a macrocell 6 including the microcells. Even though an upward transmission electric power of either a mobile station handed over to a macrocell from an adjacent macrocell or a mobile station placed in the neighborhood of a boundary of an area of a macrocell gives interference to communication of a mobile station placed in a microcell of the macrocell, a sufficiently high communication quality is maintained in the mobile station placed in the microcell against the interference. Therefore, when a compulsory hand-over is performed, a mobile station having a long round-trip time period or a measuring impossible round-trip time period is selected to be compulsorily handed over, and a communication traffic control is performed.

### TECHNICAL FIELD

The present invention relates to a communication traffic control method in a hierarchy mobile communication system in which a code division multiple access (CDMA) method is adopted as a communication method and has a plurality of mobile stations, a plurality of micro-cells (hereinafter, called microcells) and a macro-cell (hereinafter called macrocell) including the microcells.

### BACKGROUND ART

First Prior Art

In high traffic regions of urban areas, a hierarchy mobile communication system has been examined. In this mobile communication system, a plurality of microcell base stations are locally overlaid with a macrocell base station. In this mobile communication system, as compared with a case where the system is composed of only a plurality of microcell base stations, a service area can be covered with a smaller number of base stations. Therefore, the manufacturing cost of the system can be reduced. Also, in cases where processing such as call-out processing and position registration is performed in the macrocell base stations in place of the microcell base stations, the load on the microcell base stations can be reduced.

In addition, in cases where a mobile station moving at high speed is connected to a macrocell base station in place of a microcell base station, the frequent occurrence of hand-off in the microcell base station can be prevented. Also, as compared with a method for dividing a channel for two cell classes, a large channel capacity can be obtained in a method for simultaneously using the same channel in both the macrocell base station and the microcell base station.

In this case, a problem based on the interference between both two cell classes has arisen. Though the problem of the interference can be reduced by applying the dynamic channel assignment to the microcell base station, the problem of the interference still remains. For example, a user connected to a macrocell base station at a high upward transmission electric power gives interference to a user connected to a microcell base station, and this interference causes a serious problem.

Second Prior Art

The CDMA method has been recently known as a conventional mobile communication method, and the CDMA method is used for cellular phones as one of communication methods. In the CDMA method, carriers having the same frequency are used for users, and signals using the carriers can be transmitted and received at the same time in parallel to each other, and a spread spectrum (SS) communication technique is used.

In the SS communication, a transmission signal is spread with a specific spreading code on a transmission end to modulate the signal to an electric wave having both a low electric power density and a wide bandwidth, and the spread signal is demodulated on a reception end by using the same specific spreading code. Therefore, the transmission signal can be reproduced. In this case, because an undesired signal spread with a spreading code different from the specific spreading code of the transmission signal can be seen as a noise of a low electric power, the undesired signal does not disturb the demodulation of the transmission signal, and the transmission signal can be separated from the undesired signal in the demodulation as a desired signal. Therefore, a large channel capacity can be obtained in the CDMA method.

This SS communication technique is, for example, disclosed in a literature “On the Capacity of Cellular CDMA System”, written by K. S. Gilhousen, I. M. Jacobs, R. Padovani, A. J. Viterbi, L. A. Weaver Jr. and C. E. Wheatley III, IEEE Trans. Vehi. Tech., Vol. 40, No. 2, pp. 303-312, May 1991.

As is well known, a conventional mobile station is connected to a base station of a communication system through a radio line and sets up a communication link according to a prescribed protocol, and communication is performed between the conventional mobile station and the base station. The protocol is, for example, provided by Electronics Industry Association/Telecommunications Industry Association/International Standard-95A (TIA/EIA/IS-95A). In this IS-95A, the procedure from call to communication performed between a mobile station and a base station in a communication system is prescribed as follows.

An origination message is initially transmitted from the mobile station to the base station. After the reception of the origination message in the base station, a traffic channel is set up in the base station, and a base station acknowledgement order, null traffic channel data and a channel assignment message are transmitted one after another from the base station to the mobile station.

In response to both the base station acknowledgement order and the channel assignment message, the mobile station is set up for the assigned traffic channel.

Thereafter, when the null traffic channel data of two good frames successively transmitted is received in the mobile station, to assist the capturing of an upward traffic channel connected to the base station, traffic channel preamble composed of pieces of bit data of all “0” is transmitted from the mobile station to the base station. When the traffic channel preamble is received in the base station, a base station acknowledgement order is returned from the base station to the mobile station.

When the base station acknowledgement order is received in the mobile station, a mobile station acknowledgement order is returned from the mobile station to the base station, and null traffic channel data is transmitted from the mobile station to the base station to maintain connectivity with the base station.

When the mobile station acknowledgement order and the null traffic channel data are received in the base station, a service connect message is transmitted from the base station to the mobile station. When the service connect message is received in the mobile station, a mobile station acknowledgement order and a service connect completion message are transmitted from the mobile station to the base station. When base station acknowledgement order transmitted from the base station is received in the mobile station, a call connection is completed, and telephonic communication between the mobile station and the base station is started.

In the mobile radio system using the CDMA method as a communication method, because a large number of mobile stations communicate with the base station through the same frequency band, transmission waves of the mobile stations function as interference waves to interfere with each other.

To minimize the interference of each mobile station to another mobile station, electric power of the transmission waves is controlled according to a so-called open loop control, a closed lope control or an access attempt control.

However, the transmission of the traffic channel preamble from each mobile station to the base station is continued at a preset electric power until the base station acknowledgement order transmitted from the base station is received in the mobile station. This transmission electric power value of the traffic channel preamble is prescribed according to the IS-95A, and an average value of the transmission electric power of the traffic channel preamble is expressed according to a following equation.

(average transmission electric power)=−(average reception electric power)+(sum of all access prove corrections)−73+NOM POWER+INTI POWER

Here, terms of the left and right sides are respectively expressed by a unit of [dBm]. The unit of [dBm] is used to express an absolute value of the electric power. For example, 1 mW denotes a 0 level in the unit of [dBm].

When INTI POWER is equal to 0, NOM POWER denotes a correction value which is set while desiring that a correct reception electric power is received in the base station. INTI POWER denotes an adjustment value which is set while desiring that a first access channel prove signal is received at a signal electric power slightly lower than a required signal electric power. Therefore, this method compensates the partial loss of the correlation of line loss between the upward CDMA channel and the downward CDMA channel according to necessity. Here, a constant of −73 in the above equation is equal to 10×log₁₀(10^{-7.3} mW²).

The average value of the transmission electric power of the traffic channel preamble is calculated by adding a power correction value of an access channel prove, which is increased step by step until the base station acknowledgement order is received from the base station, to an average reception electric power of the base station acknowledgement order denoting a response message to a call-up or a call-in and subtracting the constant from the average reception electric power. This transmission electric power value of the traffic channel preamble denotes a minimum transmission electric power value required to receive the traffic channel preamble in the base station.

As is described above, the traffic channel preamble is transmitted at a preset electric power, and the electric power of the traffic channel preamble is set to a minimum transmission electric power value required to receive the traffic channel preamble in the base station. Therefore, a problem has sometimes arisen that the traffic channel preamble is not received in the base station and no call connection is performed. Also, in this prior art, a setting value of the transmission electric power of the traffic channel preamble in case of the mobile station linked to a microcell base station differs from that in case of the mobile station linked to a macrocell base station, and the transmission electric powers of the traffic channel preambles transmitted from mobile stations adjacent to each other differ from each other. Therefore, a problem has arisen that the communication performed in a mobile station at a high transmission electric power gives interference to the communication performed in a mobile station at a low transmission electric power.

Third Prior Art

Also, the patent application of the invention “Traffic Control Method in Hierarchy Mobile Communication System” is submitted by Nokia Telecommunications OY of Finland (Official Announcement of Japanese Patent Application H10-501393 (1998)). This invention relates to a traffic control method in a hierarchy mobile communication system. In this invention, in addition to the measurement of a radio communication line, the judgment of hand-over is considered for both a transmission electric power class of a mobile station and a cell type of an adjacent cell, and traffic is controlled by the hand-over so as to select only the adjacent cell of the cell type, which the mobile station should use according to the transmission electric power class, as a target cell for the hand-over.

However, this invention relates to the hand-over from a macrocell base station to another macrocell base station or the hand-over from a microcell base station to another microcell base station, but neither the site-diversity with both a macrocell base station and a microcell base station, the control of a transmission electric power in the hand-over, the hand-over from a macrocell base station to a microcell base station nor the hand-over from a microcell base station to a macrocell base station is described in the invention.

Fourth Prior Art

Also, the patent application of the invention “Mobile Radio Terminal” is submitted by Toshiba Corporation (Published Unexamined Japanese Patent Application 2000-341211. This invention relates to a mobile radio terminal in which a radio communication link based on the CDMA method is set up between a mobile radio terminal and a base station device connectable to a public network, and transmission control means is provided in this invention. In the transmission control means, when a prescribed preamble signal is transmitted from the mobile radio terminal to the base station device through a traffic channel assigned by the base station device, the preamble signal is transmitted while a transmission electric power of the preamble signal is increased step by step until a response indicating the reception of the preamble signal is received from the base station device.

However, this invention relates to neither a hierarchy mobile communication system nor the control of a transmission electric power in the hand-over or the site-diversity.

In a hierarchy mobile communication system having a mobile station, a plurality of microcell base stations and a macrocell base station including the microcell base stations, a traffic channel preamble is transmitted from the mobile station at a preset electric power. In cases where the electric power of the traffic channel preamble is preset to a minimum transmission electric power value required to receive the traffic channel preamble in one microcell base station included in the macrocell base station, the traffic channel preamble is not received in the macrocell base station including the microcell base station. Therefore, a problem has arisen that the site-diversity with both the macrocell base station and the microcell base station cannot be performed in the mobile station.

Also, in cases where the electric power of the traffic channel preamble is preset to a minimum transmission electric power value required to receive the traffic channel preamble in the macrocell base station, the traffic channel preamble transmitted from the mobile station considerably gives interference to another mobile station connected to the microcell base station. Therefore, a problem has arisen that a call loss is caused in the mobile station connected to the microcell base station.

The present invention is provided to solve the above-described problems, and the object of the present invention is to provide a communication traffic control method in which a traffic channel preamble is reliably transmitted from a mobile station to a macrocell base station and a call connection is performed between the mobile station and the macrocell base station through the site-diversity in a hierarchy mobile communication system while reducing the interference of the traffic channel preamble to another mobile station as little as possible.

Disclosure Of The Invention

In a communication traffic control method according to the present invention, the performance of a compulsory hand-over is determined for a mobile station for which a round-trip time period is longer than a threshold value or cannot be measured. Therefore, a large channel capacity can be obtained.

In a communication traffic control method according to the present invention, a mobile station to be compulsorily handed over is selected according to both an appropriateness judgment of a compulsory hand-over and the measurement of a round-trip time period, and a macrocell base station controls an upward transmission electric power of the mobile station, for which the compulsory hand-over is performed, within a range of values equal to or higher than an upward transmission electric power standard value set for a corresponding microcell. Therefore, a communication traffic control using the compulsory hand-over can be performed.

In a communication traffic control method according to the present invention, in cases where a mobile station transmits a prescribed preamble signal to a base station through an assigned traffic channel, the mobile station transmits the preamble signal while transmission control means of the mobile station increases a transmission electric power step by step until a response indicating the reception of the preamble signal transmitted from the base station is received in the mobile station. Therefore, a traffic channel preamble can be reliably transmitted to the base station while reducing interference to another mobile station as little as possible.

In a communication traffic control method according to the present invention, control of an upward transmission electric power is performed between a mobile station and a macrocell base station, and no control of an upward transmission electric power is performed between the mobile station and a microcell base station. Therefore, the mobile station placed in the microcell can reliably perform a site-diversity with both the macrocell and the microcell.

In a communication traffic control method according to the present invention, a mobile station to be compulsorily handed over is selected from mobile stations respectively performing a site-diversity with both the macrocell and the microcell according to both an appropriateness judgment of the compulsory hand-over and the measurement of a round-trip time period, and a macrocell base station controls an upward transmission electric power of the mobile station, for which the compulsory hand-over is performed, within a range of values equal to or higher than an upward transmission electric power standard value set for a corresponding microcell. Therefore, a communication traffic control using the compulsory hand-over can be performed.

In a communication traffic control method according to the present invention, control of a compulsory hand-over is performed according to both a result that a total volume of communication performed in a macrocell every prescribed time period is placed within a range of a macrocell channel capacity and a result that the total volume of communication is out of the range of the macrocell channel capacity. Therefore, a large channel capacity obtained can be dynamically used.

In a communication traffic control method according to the present invention, a network administrator is, if necessary, instructed to introduce a mobile relay station, and the network administrator receives a notice of information required for a relay operation. Therefore, the judgment of the network administrator is added to a communication traffic control method, and a communication traffic control method having a high reliability can be obtained.

### BRIEF DESCRIPTION OF THE DRAWINGS

FIG. 1 is a view showing the configuration of a hierarchy mobile communication system having a plurality of mobile stations, a plurality of microcell base stations and a macrocell base station including the microcell base stations according to a first embodiment of the present invention.

FIG. 2 is a sequence view showing a compulsory hand-over of a mobile station connected to a macrocell base station to a microcell base station according to the first embodiment of the present invention.

FIG. 3 is a view showing a sequence of processes in which a mobile station connected to a microcell base station finally performs a site-diversity with both the microcell base station and a macrocell base station according to the first embodiment of the present invention.

FIG. 4 is an explanatory view showing a method of dynamically using a large channel capacity of a hierarchy mobile communication system according to a second embodiment of the present invention.

FIG. 5 is a view showing the configuration of a hierarchy mobile communication system according to a third embodiment of the present invention.

### BEST MODE FOR CARRYING OUT THE INVENTION

Hereinafter, the best mode for carrying out the present invention will now be described with reference to the accompanying drawings to explain the present invention in more detail.

Embodiment 1

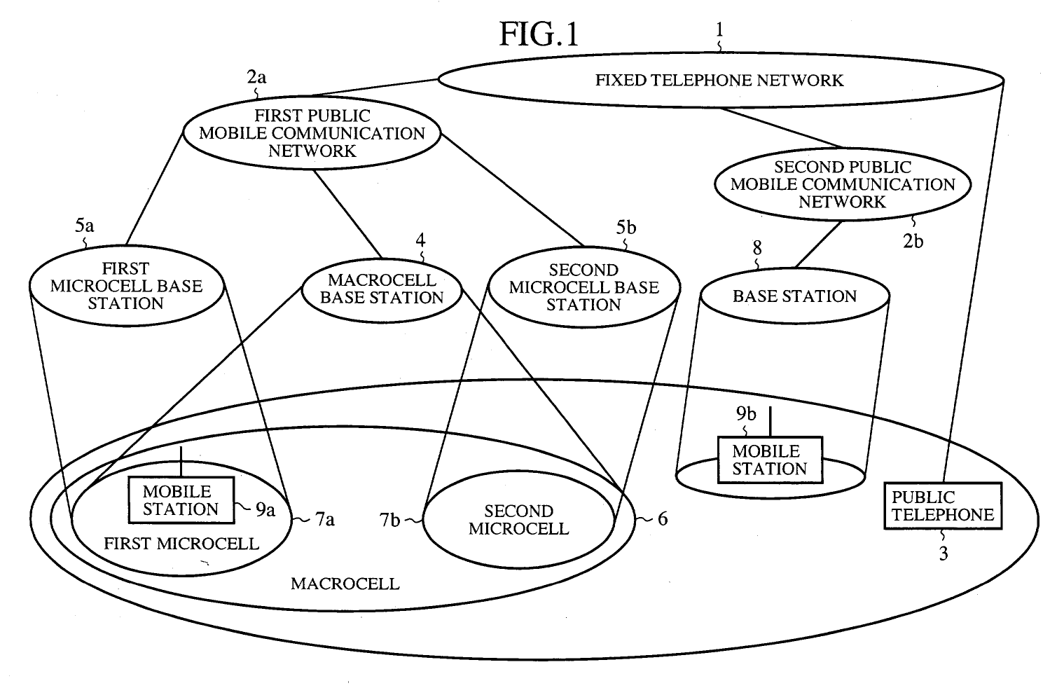

FIG. 1 is a view showing the configuration of a hierarchy mobile communication system having a plurality of mobile stations, a plurality of microcell base stations and a macrocell base station including the microcell base stations to which a communication traffic control method according to a first embodiment of the present invention is applied. In FIG. 1, 1 indicates a fixed telephone network such as a public telephone network. 2a indicates a first public mobile communication network connected to the fixed telephone network 1. 2b indicates a second public mobile communication network connected to the fixed telephone network 1. 3 indicates a public telephone connected to the fixed telephone network 1.

4 indicates a macrocell base station connected to the first public mobile communication network 2a through a communication line. A control signal includes a base station identifier denoting inherent information, and the control signal is output from the macrocell base station 4 to the first public mobile communication network 2a. 5a indicates a first microcell base station connected to the first public mobile communication network 2a through a communication line. A control signal includes a base station identifier denoting inherent information, and the control signal is output from the first microcell base station 5a to the first public mobile communication network 2a. 5b indicates a second microcell base station connected to the first public mobile communication network 2a through a communication line. A control signal includes a base station identifier denoting inherent information, and the control signal is output from the second microcell base station 5b to the first public mobile communication network 2a.

6 indicates a macrocell formed in the macrocell base station 4. In the macrocell 6, a macrocell code is formed of the base station identifier of the macrocell base station 4. 7a indicates a first microcell of the first microcell base station 5a. 7b indicates a second microcell of the second microcell base station 5b. 8 indicates a base station connected to the second public mobile communication network 2b. A control signal includes a base station identifier denoting inherent information, and the control signal is output from the base station 8 to the second public mobile communication network 2b.

9a indicates a mobile station placed in both an area of the macrocell 6 of the macrocell base station 4 and an area of the first microcell 7a of the first microcell base station 5a. The mobile station 9a is connected to the macrocell base station 4 or the first microcell base station 5a. 9b indicates a mobile station which is placed in an area of the base station 8 connected to the second public mobile communication network 2b. The mobile station 9b is connected to the base station 8.

Next, an operation will be described below.

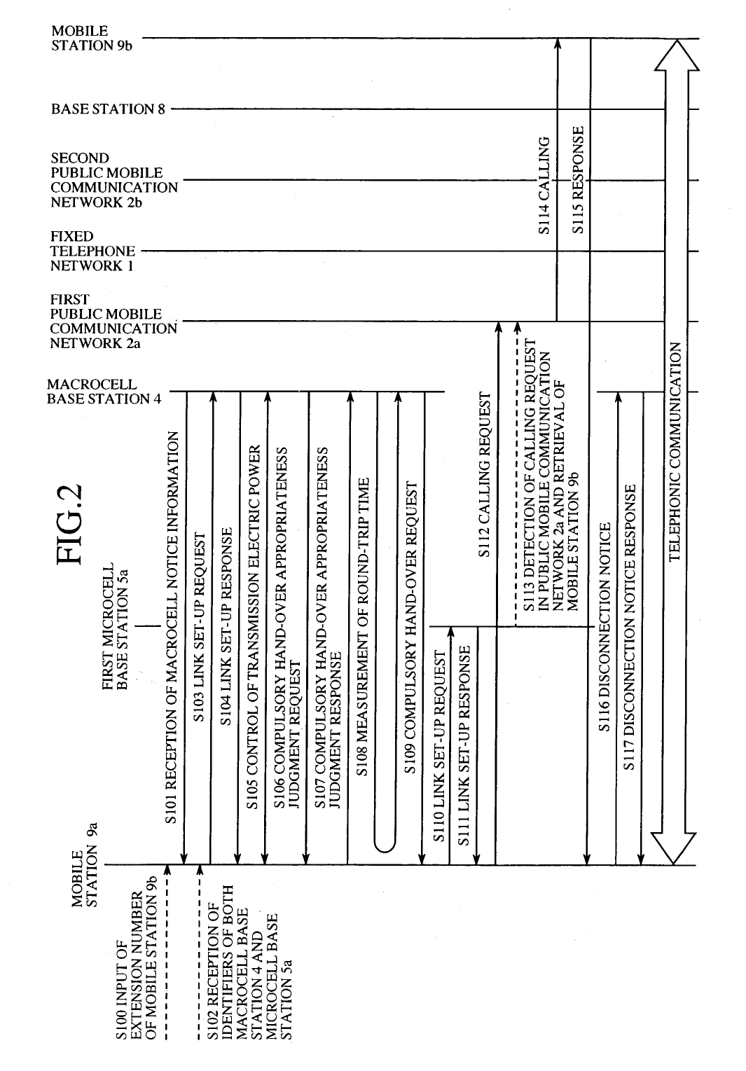

FIG. 2 is a sequence view showing processes in which the mobile station 9a is connected to the macrocell base station 4, the mobile station 9a is connected to the mobile station 9b which is placed in the area of the base station 8 connected to the second public mobile communication network 2b, the mobile station 9a is compulsorily handed over to the first microcell base station 5a, and communication is performed between the mobile station 9a and the mobile station 9b. Hereinafter, an operation of a hierarchy mobile communication system is described with reference to FIG. 2.

In a sequence of a step S100, an extension number of the mobile station 9b is input to the mobile station 9a. For example, information relating to the mobile station 9b is recorded in an information table, and an extension number “2595” recorded in an extension number column of the information table is input to the mobile station 9a. Thereafter, in the sequence of a step S101, the mobile station 9a receives information of a notice channel transmitted from the macrocell base station 4.

In the sequence of a step S102, the mobile station 9a obtains both an inherent base station identifier of the macrocell base station 4 and an inherent base station identifier of the first microcell base station 5a from the information of the notice channel received from the macrocell base station 4.

In the sequence of a step S103, the mobile station 9a transmits a link set-up request to the macrocell base station 4 while using the inherent base station identifier of the macrocell base station 4.

In the sequence of a step S104, when the macrocell base station 4 receives the link set-up request, the macrocell base station 4 transmits a link set-up response to the mobile station 9a. Therefore, a communication connection is performed between the mobile station 9a and the macrocell base station 4. In the sequence of a step S105, the control of a transmission electric power is performed between the mobile station 9a and the macrocell base station 4.

Thereafter, in the sequence of a step S106, the macrocell base station 4 transmits a compulsory hand-over appropriateness judgment request to the mobile station 9a. This judgment request inquires whether or not the mobile station 9a accepts a compulsory hand-over to the first microcell base station 5a. In the sequence of a step S107, when the mobile station 9a receives the compulsory hand-over appropriateness judgment request, the mobile station 9a performs a position measurement, and the mobile station 9a transmits a compulsory hand-over appropriateness judgment response to the macrocell base station 4. In the sequence of a step S108, when the macrocell base station 4 receives the compulsory hand-over appropriateness judgment response, a round-trip time period for the mobile station 9a is measured.

In the sequence of a step S109, in cases where the round-trip time period for the mobile station 9a is longer than a threshold value or in cases where the round-trip time period for the mobile station 9a cannot be measured, the macrocell base station 4 judges according to the measurement result of the round-trip time period that the compulsory hand-over to the first microcell base station 5a should be performed for the mobile station 9a, and the macrocell base station 4 transmits an instruction, which indicates the compulsory hand-over to the first microcell base station 5a, to the mobile station 9a.

In the sequence of a step S110, when the mobile station 9a receives the instruction of the compulsory hand-over, the mobile station 9a transmits a link set-up request to the first microcell base station 5a. In the sequence of a step S111, when the first microcell base station 5a receives the link set-up request, the first microcell base station 5a transmits a link set-up response to the mobile station 9a. In the sequence of a step S112, when the mobile station 9a receives the link set-up response, the mobile station 9a transmits a calling request to the first public mobile communication network 2a through the first microcell base station 5a.

In the sequence of a step S113, when the first public mobile communication network 2a detects this calling request, the first public mobile communication network 2a retrieves the mobile station 9b. In the sequence of a step S114, the first public mobile communication network 2a transmits a connection request to the mobile station 9b. In the sequence of a step S115, when the mobile station 9b receives this connection request, the mobile station 9b transmits a response to the mobile station 9a. In the sequence of a step S116, when the mobile station 9a receives the response from the mobile station 9b, the mobile station 9a transmits a disconnection notice to the macrocell base station 4. In the sequence of a step S117, when the macrocell base station 4 receives this disconnection notice, the macrocell base station 4 transmits a disconnection notice response to the mobile station 9a.

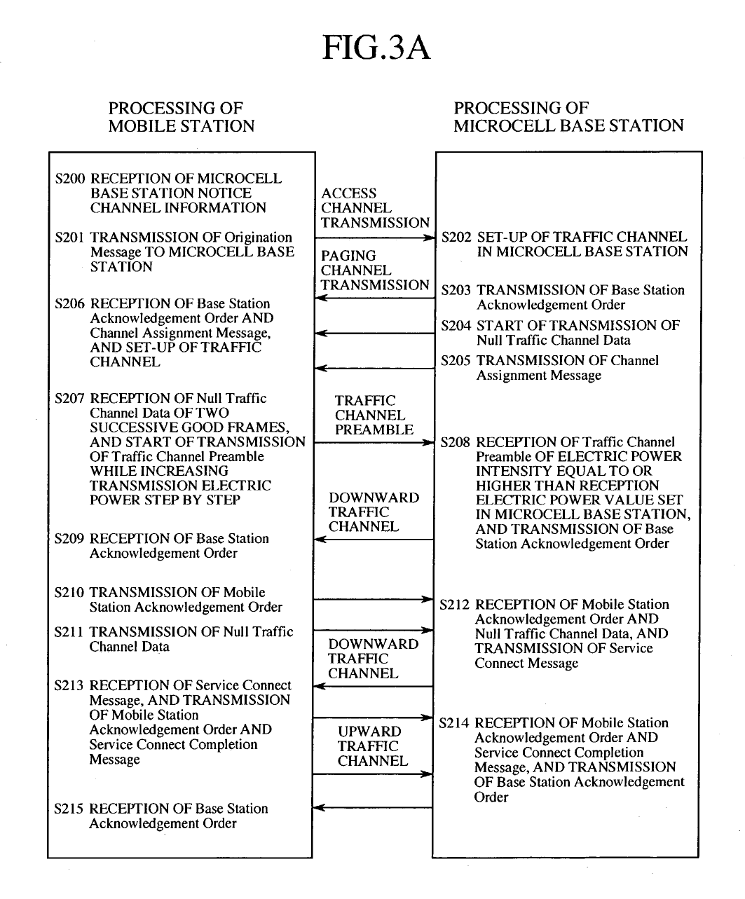

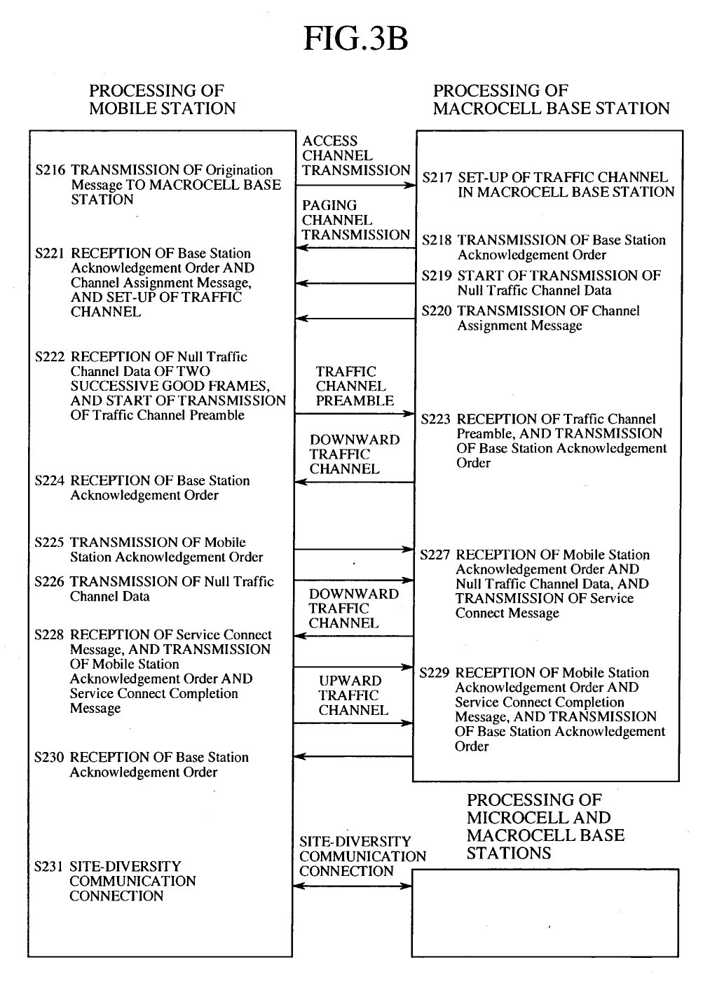

Also, FIG. 3 is a sequence view showing processes in which the mobile station 9a is connected to a microcell base station (or the first microcell base station 5a), the mobile station 9a also performs a communication connection with the macrocell base station 4, and the site-diversity is performed in the hierarchy mobile communication system having the mobile stations, the microcell base stations and the macrocell base station including the microcell base stations. Here, FIG. 3A shows the transmission and reception of signals between the mobile station 9a and the first microcell base station 5a, and FIG. 3B shows the transmission and reception of signals between the mobile station 9a and the macrocell base station 4.

Hereinafter, with reference to FIG. 3, a case where the mobile station 9a receives information of a microcell base station notice channel and downloads an upward transmission electric power standard value (which denotes an upward transmission electric power sufficient to perform a communication connection of the mobile station placed in the microcell with a macrocell) included in the information of the microcell base station notice channel will be described. Here, reference numerals of elements of the hierarchy mobile communication system shown in FIG. 1 are omitted in a following description.

In the sequence of a step S200, the mobile station 9a receives information of a microcell base station notice channel and downloads an upward transmission electric power standard value included in the information of the microcell base station notice channel. In the sequence of a step S201, the mobile station 9a transmits an origination message to the microcell base station.

In the sequence of a step S202, when the microcell base station receives the origination message, the microcell base station sets up a traffic channel. In the sequence of a step S203, the microcell base station transmits a base station acknowledgement order to the mobile station placed in the microcell. Also, in the sequence of a step S204, the microcell base station starts on transmitting null traffic channel data. In the sequence of a step S205, the microcell base station transmits a channel assignment message to the mobile station. In the sequence of a step S206, when the mobile station receives both the base station acknowledgement order and the channel assignment message, the mobile station sets up a traffic channel. Also, in the sequence of a step S207, when the mobile station receives the null traffic channel data of two good frames successively transmitted from the microcell base station, the mobile station starts on transmitting a traffic channel preamble while increasing an upward transmission electric power of the traffic channel preamble step by step until the upward transmission electric power reaches the upward transmission electric power standard value or until the mobile station receives a base station acknowledgement order transmitted from the microcell base station after the microcell base station receives the traffic channel preamble of an electric power intensity equal to or higher than a reception electric power value set in the microcell base station.

In the sequence of a step S208, when the microcell base station receives the traffic channel preamble of an electric power intensity equal to or higher than the reception electric power value set in the microcell base station, the microcell base station transmits the base station acknowledgement order to the mobile station. In the sequence of a step S209, when the mobile station receives this base station acknowledgement order, the mobile station stops the increase of the transmission electric power of the traffic channel preamble. Thereafter, in the sequence of a step S210, the mobile station transmits a mobile station acknowledgement order to the microcell base station. In the sequence of a step S211, the mobile station transmits null traffic channel data to the microcell base station.

In the sequence of a step S212, when the microcell base station receives both the mobile station acknowledgement order and the null traffic channel data from the mobile station, the microcell base station transmits a service connect message to the mobile station. In the sequence of a step S213, when the mobile station receives this service connect message from the microcell base station, the mobile station transmits both a mobile station acknowledgement order and a service connect completion message to the microcell base station.

In the sequence of a step S214, when the microcell base station receives both the mobile station acknowledgement order and the service connect completion message transmitted from the mobile station, the microcell base station transmits a base station acknowledgement order to the mobile station. In the sequence of a step S215, the mobile station receives the base station acknowledgement order transmitted from the microcell base station.

Thereafter, in the sequence of a step S216, the mobile station transmits an origination message to the macrocell base station. In the sequence of a step S217, when the macrocell base station receives the origination message, the macrocell base station sets up a traffic channel. In the sequence of a step S218, the macrocell base station transmits a base station acknowledgement order to the mobile station. Also, in the sequence of a step S219, the macrocell base station starts on transmitting null traffic channel data. In the sequence of a step S220, the macrocell base station transmits a channel assignment message to the mobile station placed in the macrocell.

In the sequence of a step S221, when the mobile station receives both the base station acknowledgement order and the channel assignment message from the macrocell base station, the mobile station sets up a traffic channel. Also, in the sequence of a step S222, when the mobile station receives the null traffic channel of two good frames successively transmitted from the macrocell base station, the mobile station starts on transmitting a traffic channel preamble to the macrocell base station.

In the sequence of a step S223, when the macrocell base station receives the traffic channel preamble from the mobile station, the macrocell base station transmits a base station acknowledgement order to the mobile station. In the sequence of a step S224, the mobile station receives this base station acknowledgement order. Thereafter, in the sequence of a step S225, the mobile station transmits a mobile station acknowledgement order to the macrocell base station. In the sequence of a step S226, the mobile station transmits null traffic channel data to the macrocell base station.

In the sequence of a step S227, when the macrocell base station receives both the mobile station acknowledgement order and the null traffic channel data, the macrocell base station transmits a service connect message to the mobile station. In the sequence of a step S228, when the mobile station receives the service connect message from the macrocell base station, the mobile station transmits a mobile station acknowledgement order and a service connect completion message to the macrocell base station.

In the sequence of a step S229, when the macrocell base station receives both the mobile station acknowledgement order and the service connect completion message from the mobile station, the macrocell base station transmits a base station acknowledgement order to the mobile station placed in the macrocell. In the sequence of a step S230, the mobile station receives the base station acknowledgement order transmitted from the macrocell base station. In the sequence of a step S231, the mobile station performs a site-diversity communication connection with both the microcell base station and the macrocell base station.

As is described above, in the first embodiment, a hierarchy mobile communication system comprises a plurality of mobile stations, a plurality of microcell base stations and a macrocell base station including the microcell base stations. Therefore, the communication between mobile stations can be performed in the hierarchy mobile communication system having a large channel capacity (or a large communication capacity). Also, because the communication traffic control using the compulsory hand-over is performed in the hierarchy mobile communication system, a mobile station placed in a microcell can maintain a sufficiently high communication quality even though an upward transmission electric power of either another mobile station handed over to a macrocell including the microcell from an adjacent macrocell or another mobile station placed in the neighborhood of a boundary of an area of a macrocell including the microcell gives interference to the mobile station placed in the microcell.

Embodiment 2

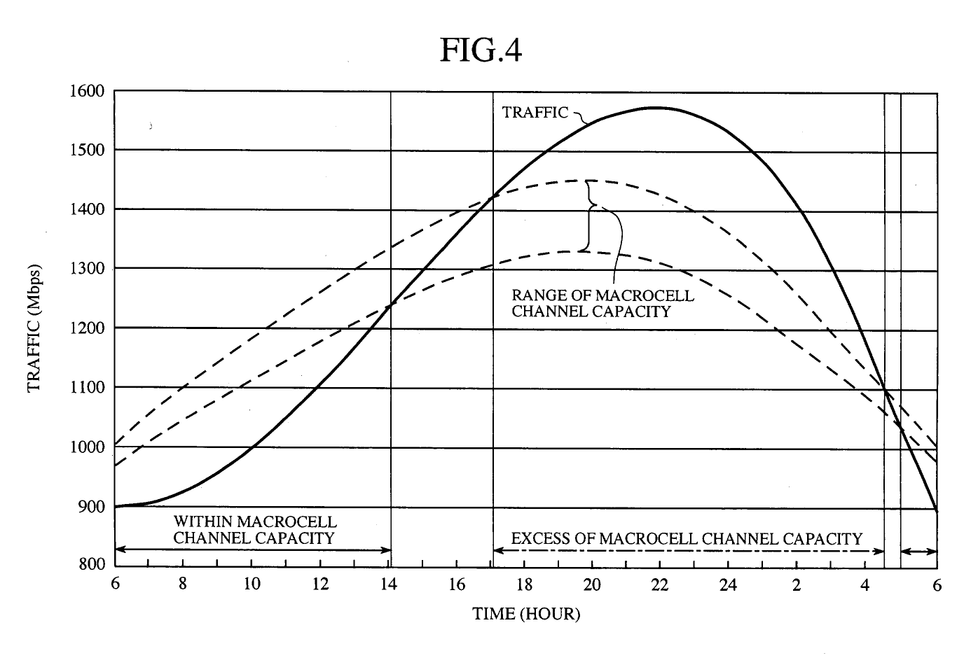

FIG. 4 is an explanatory view showing a method of dynamically using a large channel capacity of a hierarchy mobile communication system according to a second embodiment of the present invention. In FIG. 4, a Y-axis indicates traffic, and an X-axis indicates time. Also, a solid curved line indicates a traffic (or a communication traffic) denoting a total volume of communication performed in a macrocell every prescribed time period. A dotted curved line indicates an upper limit of a channel capacity (or a communication capacity) of the macrocell determined by using a high bit rate codec, and another dotted curved line indicates a lower limit of the channel capacity of the macrocell determined by using a low bit rate codec. Therefore, the dotted curved lines indicate a range of the channel capacity of the macrocell.

Here, the traffic and the channel capacity of the macrocell are respectively indicated by one curved line composed of continuous values. However, in dependence on the embodiment, it is applicable that the traffic and the channel capacity of the macrocell be respectively indicated by a bar chart in which an accumulated value is determined every prescribed time period such as thirty minutes or one hour.

In the second embodiment, as shown in FIG. 4, the range of the channel capacity of the macrocell can be changed in point of time. In the example shown in FIG. 4, because the traffic is lower than the lower limit of the channel capacity of the macrocell in both a time period from six o'clock to fourteen o'clock and a time period from five o'clock to six o'clock, the traffic is within the channel capacity of the macrocell. Also, because the traffic exceeds the upper limit of the channel capacity of the macrocell in a time period from seventeen o'clock to half past four o'clock, it is required to use a microcell. Therefore, a portion of channels connected to the macrocell base station is compulsorily handed over to the microcell base station according to the sequence shown in FIG. 2 to perform communication through the microcell base station in correspondence to a difference between the traffic and the upper limit of the channel capacity of the macrocell.

As is described above, in the second embodiment, a hierarchy mobile communication system comprises a plurality of mobile stations, a plurality of microcell base stations and a macrocell base station including the microcell base stations, and a channel capacity of the hierarchy mobile communication system is controlled to be changed every prescribed time period. Therefore, a large channel capacity obtained in the hierarchy mobile communication system can be dynamically used.

Embodiment 3

In the embodiments described above, the compulsory hand-over is automatically performed, and the communication traffic control is performed. However, it is applicable that a network administrator receives a notice indicating a result of the judgment relating to the necessity of a mobile relay unit to notify the network administrator of contents required for a relay operation.

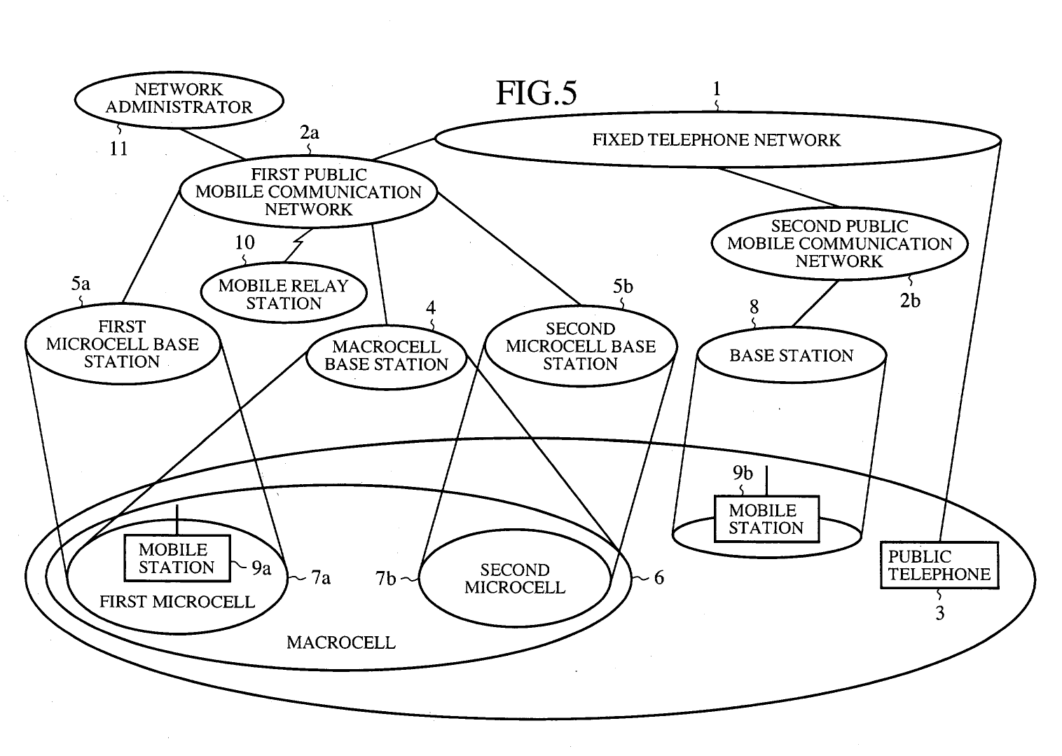

FIG. 5 is a view showing the configuration of a hierarchy mobile communication system which has a plurality of mobile stations, a plurality of microcell base stations and a macrocell base station including the microcell base stations and to which a communication traffic control method is applied according to a third embodiment of the present invention. The constituent elements, which are the same as or equivalent to those shown in FIG. 1, are indicated by the same reference numerals as those of the constituent elements shown in FIG. 1, and additional description of those constituent elements is omitted.

In FIG. 5, 10 indicates a mobile relay station radio-connected to a public mobile communication network (in the example shown in FIG. 5, the first public mobile communication network 2a). 11 indicates a network administrator, connected to the public mobile communication network (in the example shown in FIG. 5, the first public mobile communication network 2a), for controlling the introduction of the mobile relay station 10 according to a result of the judgment relating to the necessity of the mobile relay station 10.

The macrocell base station 4 judges whether or not it is required to introduce the mobile relay station 10. In cases where it is judged that the introduction of the mobile relay station 10 is required, the macrocell base station 4 instructs to the network administrator 11 the introduction of the mobile relay station 10 through a network such as the first public mobile communication network 2a, and the macrocell base station 4 notifies the network administrator 11 of contents required for a relay operation. When the network administrator 11 receives the instruction of the introduction of the mobile relay station 10, the network administrator 11 controls the introduction of the mobile relay station 10 according to the contents required for the relay operation.

As is described above, in the third embodiment, human judgment performed by the network administrator 11 is added to the communication traffic control for the hierarchy mobile communication system, and the communication traffic can be more reliably controlled.

Industrial Applicability

As is described above, a CDMA method is adopted for the communication traffic control method of the present invention, and the communication traffic control method is useful as a communication traffic control for a hierarchy mobile communication system which comprises a plurality of mobile stations, a plurality of microcell base stations and a macrocell base station including the microcell base stations. In particular, in cases where a mobile station sets up a radio communication link with a base station connectable to a public network according to the CDMA method to perform communication and transmits a prescribed preamble signal to the base station through a traffic channel assigned by the base station, the communication traffic control method of the present invention is useful and available for a system in which transmission control means continues to transmit a preamble signal while increasing a transmission electric power of the preamble signal step by step until a response indicating the reception of the preamble signal is received from abase station device and the transmission control means performs the communication traffic control.

What is claimed is:

1. A communication traffic control method, in which a communication traffic of a hierarchy mobile communication system having a plurality of mobile stations, a plurality of microcells and a macrocell including the microcells is controlled,
characterized in that the communication traffic control method comprises the step of determining that a compulsory hand-over is to be performed for one mobile station for which a round-trip time period is longer than a threshold value or cannot be measured.

2. A communication traffic control method according to claim 1, wherein the step of determining that the compulsory hand-over is to be performed comprises steps of:
performing control of a transmission electric power between each mobile station communication-connected to the macrocell and a macrocell base station of the macrocell;
making the macrocell base station perform an appropriateness judgment of the compulsory hand-over of each of all mobile stations placed in the macrocell to the corresponding microcell;
making the macrocell base station measure the round-trip time period for each mobile station of the macrocell;
making the macrocell base station select the mobile station, for which the performance of the compulsory hand-over is determined, according to both the appropriateness judgment of the compulsory hand-over of the mobile station and the round-trip time period for the mobile station;
making the macrocell base station perform the compulsory hand-over for the mobile station; and
performing control of an upward transmission electric power between the mobile station compulsorily handed over and the corresponding microcell within a range of values equal to or higher than an upward transmission electric power standard value set for the microcell.

3. A communication traffic control method, in which a communication traffic of a hierarchy mobile communication system having a plurality of mobile stations, a plurality of microcells and a macrocell including the microcells is controlled, characterized in that the communication traffic control method comprises the steps of:
making one microcell have an upward transmission electric power standard value required to communication-connect one mobile station placed in the microcell with the macrocell;
making the microcell notify the mobile station of both the upward transmission electric power standard value and a macrocell code of the macrocell included in information of a notice channel;
making the mobile station, which receives the information of the notice channel, transmit a traffic channel preamble, while increasing an upward transmission electric power of the traffic channel preamble step by step, until the upward transmission electric power reaches the upward transmission electric power standard value or until the mobile station receives a base station acknowledgement order transmitted after a microcell base station of the microcell receives the traffic channel preamble having an electric power intensity equal to or higher than a reception electric power set in the microcell base station;
making the mobile station communication-connect with both the microcell base station and a macrocell base station of the macrocell; and
performing a site-diversity between the mobile station and both the microcell base station and the macrocell base station.

4. A communication traffic control method according to claim 3, wherein the step of performing the site-diversity between the mobile station and both the microcell base station and the macrocell base station comprises steps of:
performing control of the upward transmission electric power between the mobile station and the macrocell; and
performing no control of the upward transmission electric power between the mobile station and the microcell.

5. A communication traffic control method according to claim 4, wherein the step of performing the site-diversity between the mobile station and both the microcell base station and the macrocell base station comprises steps of:
making the macrocell base station perform an appropriateness judgment of a compulsory hand-over of the mobile station to the microcell;
making the macrocell base station measure a round-trip time period for the mobile station;
making the macrocell base station determine according to both the appropriateness judgment of the compulsory hand-over of the mobile station and the round-trip time period for the mobile station that a compulsory hand-over is to be performed for the mobile station;
making the macrocell base station perform the compulsory hand-over for the mobile station; and
performing the control of the upward transmission electric power between the mobile station compulsorily handed over and the microcell within a range of values equal to or higher than an upward transmission electric power standard value set for the microcell.

6. A communication traffic control method according to claim 1, wherein the step of determining that the compulsory hand-over is to be performed comprises steps of:
setting a range of a channel capacity of the macrocell as a range of a macrocell channel capacity set every prescribed time period;
performing control of the compulsory hand-over according to both a result that a total volume of communication performed in the macrocell every prescribed time period is placed within the range of the macrocell channel capacity and a result that the total volume of communication is out of the range of the macrocell channel capacity.

7. A communication traffic control method according to claim 1, further comprising the steps of:
judging whether or not it is required to introduce a mobile relay station;
instructing a network administrator through a network that the network administrator introduces the mobile relay station, in cases where it is judged that it is required to introduce the mobile relay station; and
notifying the network administrator of contents required for a relay operation.
